(19) United States
(12) Patent Application Publication
(10) Pub. No.: US 2023/0036864 A1
(43) Pub. Date: Feb. 2, 2023

(54) METHOD AND APPARATUS FOR DETECTING TRAFFIC ANOMALY

(71) Applicant: Beijing Baidu Netcom Science Technology Co., Ltd., Beijing (CN)

(72) Inventors: Wenhao WU, Beijing (CN); Yuxiang Zhao, Beijing (CN)

(73) Assignee: Beijing Baidu Netcom Science Technology Co., Ltd., Beijing (CN)

(21) Appl. No.: 17/963,058

(22) Filed: Oct. 10, 2022

Related U.S. Application Data
(63) Continuation of application No. PCT/CN2022/075071, filed on Jan. 29, 2022.

(30) Foreign Application Priority Data
Apr. 28, 2021 (CN) 202110466631.2

(51) Int. Cl. G06V 20/54; G08G 1/052; G08G 1/056; G08G 1/16; G06V 10/762

(52) U.S. Cl. CPC G06V 20/54; G06V 10/762; G08G 1/052; G08G 1/056; G08G 1/164

(57) ABSTRACT

The present disclosure provides a method and apparatus for detecting a traffic anomaly, relates to the field of artificial intelligence and specifically to computer vision and deep learning technologies, and can be applied to video analysis scenarios. A specific implementation comprises: acquiring at least two frames of consecutive traffic images; identifying respectively a position of a target vehicle from the at least two frames of consecutive traffic images to obtain a position information set; determining a direction of travel and speed of the target vehicle according to the position information set; and comparing the direction of travel and speed of the target vehicle with a pre-generated vehicle vector field to determine whether the target vehicle is abnormal.

### CROSS-REFERENCE TO RELATED APPLICATION

This patent application is a continuation of International Application No. PCT/CN2022/075071, filed on Jan. 29, 2022, which claims the priority from Chinese Patent Application No. 202110466631.2, filed on Apr. 28, 2021 and entitled “Method and Apparatus for Detecting Traffic Anomaly,” the entire disclosure of which is hereby incorporated by reference.

### TECHNICAL FIELD

The present disclosure relates to the field of artificial intelligence, specifically to computer vision and deep learning technologies, and particularly to a method and apparatus for detecting a traffic anomaly, and can be applied to video analysis scenarios.

### BACKGROUND

Anomaly detections in traffic scenarios are for vehicles having an anomaly on a main road, for example, having a crash, stalling, deviating from the main road, and traveling in a reverse direction. Traditional video traffic monitoring is dependent on the judgments of observers, which needs to consume a lot of manpower, resulting in a low efficiency. A visual anomaly detection system generated accordingly is to detect an abnormal vehicle using the computer vision.

In the prior art, the method of detecting an abnormal traffic event using a computer has good robustness in different scenarios.

### SUMMARY

The present disclosure provides a method and apparatus for detecting a traffic anomaly, a device, a storage medium and a computer program product.

In a first aspect, embodiments of the present disclosure provide a method for detecting a traffic anomaly, comprising: acquiring at least two frames of consecutive traffic images; identifying respectively a position of a target vehicle from the at least two frames of consecutive traffic images to obtain a position information set; determining a direction of travel and speed of the target vehicle according to the position information set; and comparing the direction of travel and speed of the target vehicle with a pre-generated vehicle vector field to determine whether the target vehicle is abnormal.

In a second aspect, embodiments of the present disclosure provide an apparatus for detecting a traffic anomaly, comprising: an acquiring unit, configured to acquire at least two frames of consecutive traffic images; an identifying unit, configured to identify respectively a position of a target vehicle from the at least two frames of consecutive traffic images to obtain a position information set; a determining unit, configured to determine a direction of travel and speed of the target vehicle according to the position information set; and a detecting unit, configured to compare the direction of travel and speed of the target vehicle with a pre-generated vehicle vector field to determine whether the target vehicle is abnormal.

In a third aspect, embodiments of the present disclosure provide an electronic device, comprising: one or more processors; and a memory, storing one or more programs, wherein the one or more programs, when executed by the one or more processors, cause the one or more processors to implement the method for detecting a traffic anomaly provided by the first aspect.

In a fourth aspect, embodiments of the present disclosure provide a computer-readable medium, storing a computer program thereon, wherein the program, when executed by a processor, causes the processor to implement the method provided by the first aspect.

In a fifth aspect, an embodiment of the present disclosure provides a computer program product, comprising a computer program, wherein the computer program, when executed by a processor, implements the method provided by the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

Accompanying drawings are used for a better understanding of the scheme, and do not constitute a limitation to the present disclosure. Here:

FIG. 1 illustrates an exemplary system architecture in which an embodiment of the present disclosure may be applied;

FIG. 2 is a flowchart of an embodiment of a method for detecting a traffic anomaly according to the present disclosure;

FIG. 3 is a schematic diagram of an application scenario of the method for detecting a traffic anomaly according to the present disclosure;

FIG. 4 is a flowchart of another embodiment of the method for detecting a traffic anomaly according to the present disclosure;

FIG. 5 is a schematic diagram of another application scenario of the method for detecting a traffic anomaly according to the present disclosure;

FIG. 6 is a schematic structural diagram of an embodiment of an apparatus for detecting a traffic anomaly according to the present disclosure; and

FIG. 7 is a block diagram of an electronic device used to implement the method for detecting a traffic anomaly according to the embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

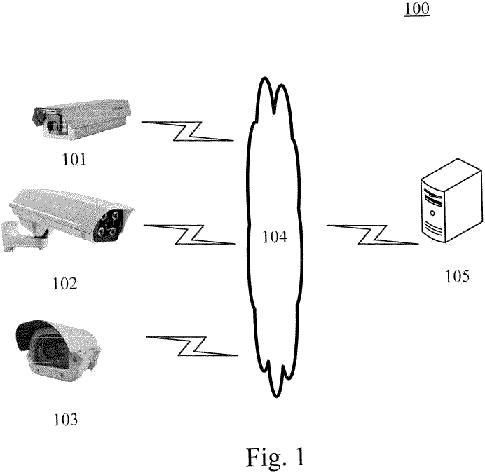

FIG. 1 illustrates an exemplary system architecture 100 in which an embodiment of a method for detecting a traffic anomaly or an apparatus for detecting a traffic anomaly according to the present disclosure may be applied.

As shown in FIG. 1, the system architecture 100 may include cameras 101, 102 and 103, a network 104 and a server 105. The network 104 serves as a medium providing a communication link between the cameras 101, 102 and 103 and the server 105. The network 104 may include various types of connections, for example, wired or wireless communication links, or optical fiber cables.

A user may use the cameras 101, 102 and 103 to interact with the server 105 via the network 104 to receive or send messages, etc.

The cameras 101, 102 and 103 generally refer to cameras that are used to monitor vehicles and can identify vehicle information (e.g., a license plate number and a vehicle model). The cameras 101, 102 and 103 may be electronic police systems snapping vehicle violating regulations (e.g., crossing a solid line to change a lane, traveling in a reverse direction, occupying a non-motor vehicle lane, traveling not according to guide signs, and running a red light) at an intersection. Alternatively, the cameras 101, 102 and 103 may be bayonet cameras provided at some key road sections of a highway, a provincial highway and a national highway for snapping vehicles traveling over a speed limit. Alternatively, the cameras 101, 102 and 103 may be cameras snapping vehicles stopping in violation of regulations, flow monitoring cameras, skynet monitoring cameras, mobile snap cameras, or the like.

The server 105 may be a server providing various services. For example, the server 105 may be a backend analysis server providing an analyse for the vehicle data collected by the cameras 101, 102 and 103. The backend analysis server may perform processing such as an analysis on received vehicle data, and output the processing result (e.g., an abnormal situation such as traveling in a reverse direction, a collision, stalling and a breakdown).

It should be noted that the server 105 may be hardware or software. When being the hardware, the server may be implemented as a distributed server cluster composed of a plurality of servers, or may be implemented as a single server. When being the software, the server may be implemented as a plurality of pieces of software or a plurality of software modules (e.g., software or software modules for providing a distributed service), or may be implemented as a single piece of software or a single software module, which will not be specifically defined here. The server may alternatively be a server of a distributed system, or a server combined with a blockchain. The server may alternatively be a cloud server, or an intelligent cloud computing server or intelligent cloud host with artificial intelligence technology.

It should be noted that the method for detecting a traffic anomaly provided in the embodiments of the present disclosure is generally performed by the server 105, and correspondingly, the apparatus for detecting a traffic anomaly is generally provided in the server 105.

It should be appreciated that the numbers of the cameras, the networks, and the servers in FIG. 1 are merely illustrative. Any number of cameras, networks, and servers may be provided based on actual requirements.

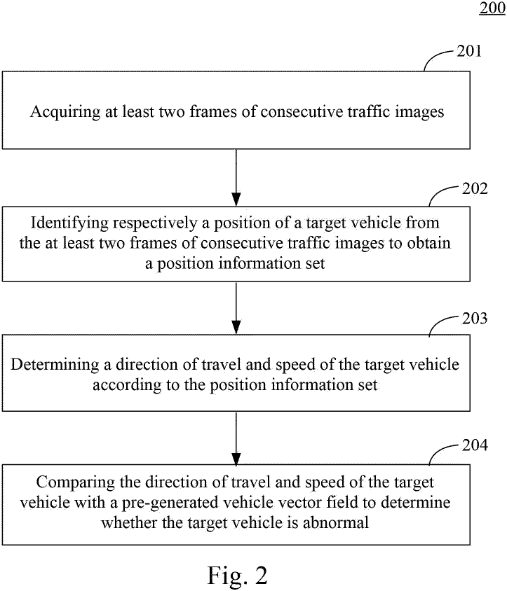

Further referring to FIG. 2, FIG. 2 illustrates a flow 200 of an embodiment of a method for detecting a traffic anomaly according to the present disclosure. The method for detecting a traffic anomaly includes the following steps:

Step 201, acquiring at least two frames of consecutive traffic images.

In this embodiment, an executing body (e.g., the server shown in FIG. 1) of the method for detecting a traffic anomaly may receive the at least two frames of consecutive traffic images from a camera by means of a wired connection or a wireless connection. The acquired traffic images are photographed from the same angle by the same camera at the same position. Since the traveling direction and speed of a vehicle need to be determined through images, at least two frames of images are required to determine the change of the position of the vehicle. In practical use, a segment of video including a plurality of frames of images may be acquired. The frame rate of the camera is generally 25 to 30 frames per second. The time interval between different traffic images may be determined according to the frame rate.

Step 202, identifying respectively a position of a target vehicle from the at least two frames of consecutive traffic images to obtain a position information set.

In this embodiment, the vehicle in a traffic image may be identified using a multi-target tracking algorithm (e.g., a deepsort algorithm) in the prior art. Here, the target vehicle refers to a vehicle that can be tracked and identified. Generally, there will be a plurality of vehicles in one traffic image, and thus, there will be a plurality of target vehicles. A target vehicle can be detected in each traffic image, and then bounded using a detection box. The position of the center point of the detection box can be used as the position of the target vehicle. These center points are connected to form the trajectory of the vehicle and can be represented by a position information set. Each piece of position information refers to the coordinate position of the center point of the detection box in the image.

Step 203, determining a direction of travel and speed of the target vehicle according to the position information set.

In this embodiment, the traveling route (i.e., the direction) of the target vehicle can be determined according to the change of the position of the center point of the detection box. The mapping relationship between a pixel-point distance and an actual distance is determined according to the known camera parameters of the camera. After the target vehicle moves, the distance by which the target vehicle actually moves can be calculated according to the distance by which the center point of the detection box moves and the mapping relationship. Then, the speed of the target vehicle can be calculated by calculating the time the target vehicle travels according to the frame rate.

Step 204, comparing the direction of travel and speed of the target vehicle with a pre-generated vehicle vector field to determine whether the target vehicle is abnormal.

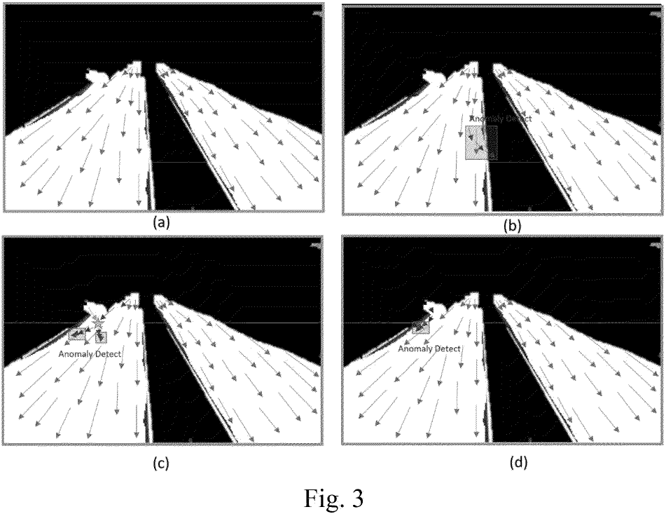

In this embodiment, the vehicle vector field may be automatically generated according to historical data or may be manually calibrated. The vehicle vector field includes the traveling direction and speed of the vehicle. The direction of the vehicle vector field is as shown in FIG. 3, frame(a). The speed may be the average speed of a large number of vehicles that have passed through the road section photographed by the camera. The direction of travel of the currently detected target vehicle is compared with the direction of the vehicle vector field, and if the directions are opposite, it indicates that the target vehicle travels in a reverse direction. Moreover, the speed of the currently detected target vehicle can be compared with the speed of the vehicle vector field, and if a certain range is exceeded, it indicates that the target vehicle is abnormal. For example, the vehicle speed of the target vehicle is less than 0.5 times the speed of the vehicle vector field, or the vehicle speed of the target vehicle is greater than 1.5 times the speed of the vehicle vector field. If the speed of the vehicle vector field is 60 km/h, the vehicle speed of the target vehicle is abnormal when the vehicle speed of the target vehicle is less than 30 km/h (the vehicle speed being abnormally low) or greater than 90 km/h (the vehicle speed being abnormally high). If the number of vehicles having an abnormally low vehicle speed reaches a predetermined vehicle threshold, it indicates that congestion occurs in the road section, and prompt information can be outputted to a monitoring person, to prompt the person to further check whether there is a traffic accident.

The position of the abnormal vehicle can further be directly positioned to facilitate a rescue. Once the abnormal vehicle is detected, the information of the vehicle owner can be acquired by identifying the license plate. In addition to identity information, the information of the vehicle owner may include relevant information such as the contact information of the vehicle owner and a family members, and a medical history (e.g., asthma, and a heart disease). The traffic control department may alternatively be notified for processing. The traffic control department can find the vehicle according to the position, and arrange a trailer if the vehicle breaks down. If the vehicle owner is taken ill, it is possible to give first aid according to the medical history identified in advance, and contact a family member.

According to the method provided in the above embodiment of the present disclosure, by comparing the direction and speed of the vehicle that are obtained by tracking and detecting the vehicle with the known vehicle vector field, the abnormal vehicle can be quickly and accurately determined, and relevant information is provided for subsequent processing, and thus, the abnormal vehicle can be quickly solved.

According to the method for detecting a traffic anomaly that are provided by the embodiments of the present disclosure, the vehicle vector field is obtained by tracking the vehicle, and the abnormal vehicle is determined according to the vehicle vector field. In this way, the analysis on situations such as traveling in a reverse direction, a collision, stalling and a breakdown can be implemented. Accordingly, the massive computing demands generated by the global use of deep learning networks are effectively solved, and the current anomaly analysis through vehicle monitoring is improved.

In some alternative implementations of this embodiment, the comparing the direction of travel and speed of the target vehicle with a pre-generated vehicle vector field to determine whether the target vehicle is abnormal includes: comparing the direction of travel of the target vehicle with a direction of the vehicle vector field, and determining that a trajectory of the target vehicle is abnormal if an included angle exceeds a predetermined threshold. If the included angle exceeds the predetermined threshold value, it indicates that the vehicle changes a lane. In order to filter out the situation where the vehicle normally changes a lane and overtake a vehicle, a plurality of frames can be continuously monitored. If the obtained trajectory is not a normal lane change trajectory, it indicates that the vehicle is abnormal. When the included angle is approximately 180 degrees, it indicates that the vehicle travels in the reverse direction. In this way, an anomaly detection can be performed without manually annotating the traveling direction of the vehicle, thereby improving the flexibility of the detection. This method can be applied to any unannotated road section.

In some alternative implementations of this embodiment, it is determined that a vehicle collision occurs in response to determining that a number of vehicles of which trajectories are abnormal at a given position exceeds 2. In the same group of images, if the number of the vehicles of which the trajectories are abnormal at the given position exceeds 2, it indicates that at least two vehicles collide, as shown in frame(c) in FIG. 3. The traffic accident can be quickly and accurately detected, and the license plate of a vehicle in the accident can also be quickly detected, to notify the related insurance company for processing. The related video is directly retained as the evidence for reporting a case, without requiring the traffic policeman to view the video from the beginning to the end to find the time when the accident occurs. According to the technical solution of the present disclosure, the time when the accident occurs can be directly positioned, which facilitates the traffic control department in quickly screening the cause of the accident and dividing the responsibility for the accident. Thus, the efficiency of dealing with the traffic accident is improved.

Further referring to FIG. 3, FIG. 3 is a schematic diagram of an application scenario of the method for detecting a traffic anomaly according to this embodiment. In the application scenario of FIG. 3, a vehicle vector field in a normal situation is as shown in frame(a). The white area in the drawing is a road. It can be seen that the traveling directions of the vehicles on the two roads are the same. Frame(b) shows a situation where a vehicle travels out of a road. Whether the vehicle travels out of the road can be determined according to whether the position of the detection box of the vehicle is in a road area. If the vehicle travels out of the road, it indicates that there is a traffic accident. Frame(c) shows vehicle trajectories when two vehicles collide. The directions of the two vehicles are different from the vector field, and the deviation is large. Frame(d) shows that a vehicle stalls or breaks down. On the basis that a number of frames in which the detection boxes overlap exceeds a predetermined frame number threshold, it can be determined that the vehicle does not move and the vehicle is in the road area, to avoid an error detection on a vehicle in a parking lot.

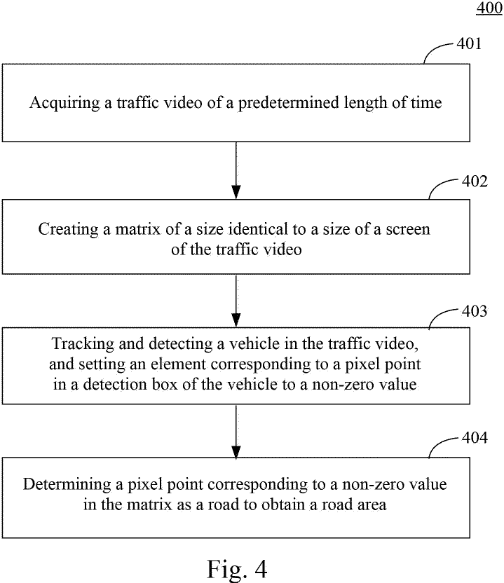

Further referring to FIG. 4, FIG. 4 illustrates a flow 400 of another embodiment of the method for detecting a traffic anomaly. The flow 400 of the method for detecting a traffic anomaly includes the following steps:

Step 401, acquiring a traffic video of a predetermined length of time.

In this embodiment, an executing body (e.g., the server shown in FIG. 1) of the method for detecting a traffic anomaly may receive the traffic video of the predetermined length of time from a camera by means of a wired connection or a wireless connection. The length of time is related to a collection time. In a traffic peak period, a collection needs to be performed for a short time. In a traffic valley period, the collection needs to be performed for a long time. The camera same as that in step 201 is used to collect the video from the same angle at the same position. In this way, it is ensured that the divided road area in the video can be used in the flow 200.

Step 402, creating a matrix of a size identical to a size of a screen of the traffic video.

In this embodiment, each element in the matrix represents one pixel point on the screen, and the initial value of the each element is zero. For example, if the video resolution is 900*1024, an all-zero matrix of 900*1024 is created.

Step 403, tracking and detecting a vehicle in the traffic video, and setting an element corresponding to a pixel point in a detection box of the vehicle to a non-zero value.

In this embodiment, when each time a vehicle is detected, a pixel point in the detection box is marked as a road, and an element at a corresponding position in the matrix can be set to a non-zero value, for example, 1.

$$\text{Assuming} \text{that} \text{the} \text{initial} \text{matrix} \text{is} \begin{matrix}\text{0} & \text{0} & \text{0} \\ \text{0} & \text{0} & \text{0} \\ \text{0} & \text{0} & \text{0}\end{matrix} \text{,} \text{and}$$

vehicles are detected at positions (0,1), (1,1) and

$$\left(\text{2,1}\right) \text{in} \text{an} \text{image,} \text{the} \text{matrix} \text{is} \text{modified} \text{to} \begin{matrix}\text{0} & \text{1} & \text{0} \\ \text{0} & \text{1} & \text{0} \\ \text{0} & \text{1} & \text{0}\end{matrix} \text{.}$$

Step 404, determining a pixel point corresponding to a non-zero value in the matrix as a road to obtain a road area.

In this embodiment, the pixel point of the non-zero value determined in step 403 is connected to constitute the road area.

Alternatively, the road area may be re-determined according to steps 401-404 when the anomaly detection rate increases to a predetermined threshold. Since the angle of the camera may be slightly changed due to a strong wind or the like, the anomaly determination will be inaccurate when performed according to the originally determined road area, which will result in a situation where it is detected that a large number of vehicles are abnormal (e.g., that the large number of vehicles travel out of a road). Thus, a correction needs to be performed on the road area. The vehicle in the currently photographed image can be accurately detected using the corrected road area.

According to the method provided in the above embodiment of the present disclosure, the road is determined through the actually passing vehicles rather than a road identification performed using a road identification model, because the road identification model will detect a parking lot as a road by mistake. Moreover, in the method, the road can be annotated again at any time as required. As compared with the manual annotation, the road area can be updated in time according to a current situation, thereby avoiding an error detection.

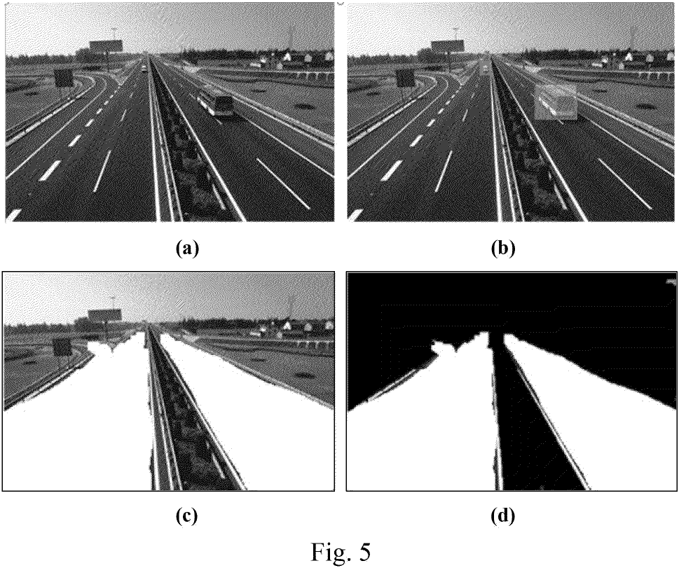

Further referring to FIG. 5, FIG. 5 is a schematic diagram of an application scenario of the method for detecting a traffic anomaly according to this embodiment. In the application scenario of FIG. 5, Frame(a) shows a traffic image photographed by a camera. Frame(b) shows that a vehicle is detected through a tracking algorithm, the vehicle being bounded by a detection box. Frame(c) shows that the pixel points in an area where the detection box is are filled with a white color. Frame(d) shows that a non-white area is set to a road area and areas of other colors are set to non-road areas, which are all filled with a black color.

In some alternative implementations of this embodiment, the method further includes: obtaining a vehicle trajectory set according to a change of a position of the detection box of the vehicle, and performing a cluster analysis on the vehicle trajectory set to generate a vehicle vector field. The cluster analysis may be performed through a common clustering algorithm such as kmeans. The final clustering result is a trajectory classified by lane, the trajectory including a direction. According to the trajectory of each lane, the average speed of vehicles passing through this lane. The speed and the direction constitute a vector field. The vector field is more conveniently and quickly obtained in this way than using a manual annotation method. In addition, the vector field can be updated in real time according to the current situation. For example, for reasons such as a congestion, the directions of some lanes are temporarily changed (see tidal lanes). In this case, through the method in the present disclosure, the vector field can be updated in time without an error determination.

In some alternative implementations of this embodiment, comparing a direction of travel and speed of a target vehicle with a pre-generated vehicle vector field to determine whether the target vehicle is abnormal includes: determining that the target vehicle stops abnormally, in response to determining that a time during which a position of the target vehicle is in the road area and the speed is zero exceeds a predetermined duration threshold. If the detection boxes overlap, it indicates that the vehicle does not move and the speed is 0. The stopping time can be determined by the number of frames in which the detection boxes overlap. If the stopping time exceeds the predetermined duration threshold, whether the vehicle stops abnormally can not be determined yet, and it is required to further determine whether the vehicle is in the road area at this time. If the vehicle stops in the road area, the stopping is an abnormal stop. If the vehicle stops outside the road, the traveling of other vehicles will not be impeded. According this method, it can be quickly and accurately detected that the vehicle stops abnormally, such that processing is performed as soon as possible, for example, notifying other drivers through traffic broadcasting to be careful of a crash, or allowing them to change a lane in advance.

In some alternative implementations of this embodiment, the comparing a direction of travel and speed of a target vehicle with a pre-generated vehicle vector field to determine whether the target vehicle is abnormal includes: determining that the target vehicle travels out of a road, in response to detecting that the target vehicle travels into a non-road area from the road area. Traveling out of the road is also an anomaly, which may be caused by a tire burst or the like. According to the method, it is quickly and accurately detected that the vehicle travels out of the road, and thus, it is possible to quickly notify a traffic control department of the position of an accident, to perform rescue in time, thereby avoiding a secondary injury.

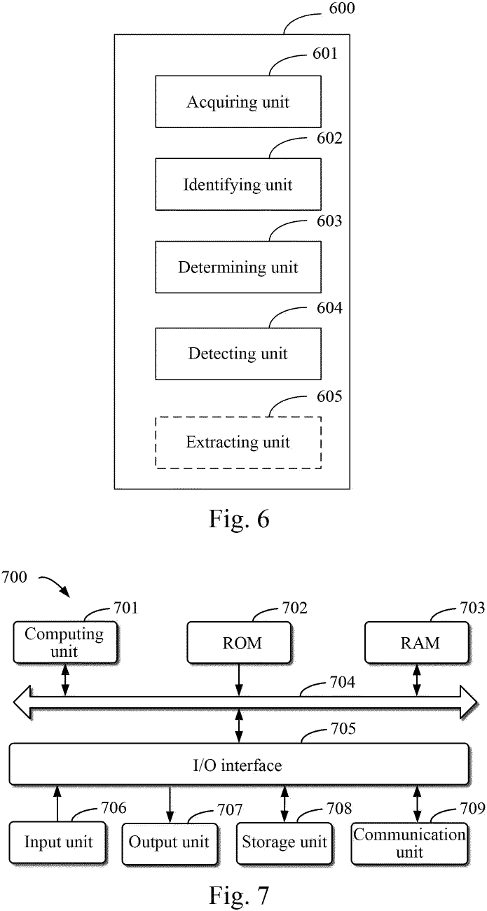

Further referring to FIG. 6, as an implementation of the method shown in the above drawings, the present disclosure provides an embodiment of an apparatus for detecting a traffic anomaly. The embodiment of the apparatus corresponds to the embodiment of the method shown in FIG. 2, and the apparatus may be applied in various electronic devices.

As shown in FIG. 6, the apparatus 600 for detecting a traffic anomaly in this embodiment includes: an acquiring unit 601, an identifying unit 602, a determining unit 603 and a detecting unit 604. Here, the acquiring unit 601 is configured to acquire at least two frames of consecutive traffic images. The identifying unit 602 is configured to identify respectively a position of a target vehicle from the at least two frames of consecutive traffic images to obtain a position information set. The determining unit 603 is configured to determine a direction of travel and speed of the target vehicle according to the position information set. The detecting unit 604 is configured to compare the direction of travel and speed of the target vehicle with a pre-generated vehicle vector field to determine whether the target vehicle is abnormal.

In this embodiment, for specific processes of the acquiring unit 601, the identifying unit 602, the determining unit 603 and the detecting unit 604 in the apparatus 600 for detecting a traffic anomaly, reference may be made to step 201, step 202, step 203 and step 204 in the corresponding embodiment of FIG. 2.

In some alternative implementations of this embodiment, the apparatus 600 further includes an extracting unit 605. The extracting unit 605 is configured to: acquire a traffic video of a predetermined length of time; create a matrix of a size identical to a size of a screen of the traffic video, wherein each element in the matrix represents one pixel point on the screen, and an initial value of the each element is zero; track and detect a vehicle in the traffic video, and set an element corresponding to a pixel point in a detection box of the vehicle to a non-zero value; and determine a pixel point corresponding to a non-zero value in the matrix as a road to obtain a road area.

In some alternative implementations of this embodiment, the extracting unit 605 is further configured to: obtain a vehicle trajectory set according to a change of a position of the detection box of the vehicle; and perform a cluster analysis on the vehicle trajectory set to generate a vehicle vector field.

In some alternative implementations of this embodiment, the detecting unit 604 is further configured to: determine that the target vehicle stops abnormally, in response to determining that a time during which the position of the target vehicle is in the road area and the speed is zero exceeds a predetermined duration threshold.

In some alternative implementations of this embodiment, the detecting unit 604 is further configured to: determine that the target vehicle travels out of the road, in response to detecting that the target vehicle travels into a non-road area from the road area.

In some alternative implementations of this embodiment, the detecting unit 604 is further configured to: compare the direction of travel of the target vehicle with a direction of the vehicle vector field, and determine that a trajectory of the target vehicle is abnormal if an included angle exceeds a predetermined threshold.

In some alternative implementations of this embodiment, the detecting unit 604 is further configured to: determine that a vehicle collision occurs, in response to determining that a number of vehicles of which trajectories are abnormal at a given position exceeds 2.

According to an embodiment of the present disclosure, the present disclosure further provides an electronic device, a readable storage medium, and a computer program product.

An electronic device includes: at least one processor; and a storage device, in communication with the at least one processor. Here, the storage device stores instructions executable by the at least one processor, and the instructions are executed by the at least one processor, to enable the at least one processor to perform the method according to the flow 200 or the flow 400.

A non-transitory computer readable storage medium stores a computer instruction. Here, the computer instruction is used to cause the computer to perform the method according to the flow 200 or the flow 400.

A computer program product includes a computer program. The computer program, when executed by a processor, implements the method according to the flow 200 or the flow 400.

FIG. 7 is a schematic block diagram of an exemplary electronic device 700 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 7, the device 700 includes a computation unit 701, which may execute various appropriate actions and processes in accordance with a computer program stored in a read-only memory (ROM) 702 or a computer program loaded into a random access memory (RAM) 703 from a storage unit 708. The RAM 703 also stores various programs and data required by operations of the device 700. The computation unit 701, the ROM 702 and the RAM 703 are connected to each other through a bus 704. An input/output (I/O) interface 705 is also connected to the bus 704.

The following components in the device 700 are connected to the I/O interface 705: an input unit 706, for example, a keyboard and a mouse; an output unit 707, for example, various types of displays and a speaker; a storage device 708, for example, a magnetic disk and an optical disk; and a communication unit 709, for example, a network card, a modem, a wireless communication transceiver. The communication unit 709 allows the device 700 to exchange information/data with an other device through a computer network such as the Internet and/or various telecommunication networks.

The computation unit 701 may be various general-purpose and/or special-purpose processing assemblies having processing and computing capabilities. Some examples of the computation unit 701 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 701 performs the various methods and processes described above, for example, the method for detecting a traffic anomaly. For example, in some embodiments, the method for detecting a traffic anomaly may be implemented as a computer software program, which is tangibly included in a machine readable medium, for example, the storage device 708. In some embodiments, part or all of the computer program may be loaded into and/or installed on the device 700 via the ROM 702 and/or the communication unit 709. When the computer program is loaded into the RAM 703 and executed by the computation unit 701, one or more steps of the above method for detecting a traffic anomaly may be performed. Alternatively, in other embodiments, the computation unit 701 may be configured to perform the method for detecting a traffic anomaly through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a distributed system server, or a server combined with a blockchain. The server may be a cloud server, or an intelligent cloud computing server or intelligent cloud host with artificial intelligence technology.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for detecting a traffic anomaly, the method comprising:
acquiring at least two frames of consecutive traffic images;
identifying respectively a position of a target vehicle from the at least two frames of consecutive traffic images to obtain a position information set;
determining a direction of travel and speed of the target vehicle according to the position information set; and
comparing the direction of travel and speed of the target vehicle with a pre-generated vehicle vector field to determine whether the target vehicle is abnormal.

2. The method according to claim 1, further comprising:
acquiring a traffic video of a predetermined length of time;
creating a matrix of a size identical to a size of a screen of the traffic video, wherein each element in the matrix represents one pixel point on the screen, and an initial value of each element in the matrix is zero;
tracking and detecting a vehicle in the traffic video, and setting an element corresponding to a pixel point in a detection box of the vehicle to a non-zero value; and
determining a pixel point corresponding to a non-zero value in the matrix as a road to obtain a road area.

3. The method according to claim 2, further comprising:
obtaining a vehicle trajectory set according to a change of a position of the detection box of the vehicle; and
performing a cluster analysis on the vehicle trajectory set to generate a vehicle vector field.

4. The method according to claim 2, wherein comparing the direction of travel and speed of the target vehicle with the pre-generated vehicle vector field to determine whether the target vehicle is abnormal comprises:
determining that the target vehicle stops abnormally in response to determining that a time during which the position of the target vehicle is in the road area and the speed is zero exceeds a predetermined duration threshold.

5. The method according to claim 2, wherein comparing the direction of travel and speed of the target vehicle with the pre-generated vehicle vector field to determine whether the target vehicle is abnormal comprises:
determining that the target vehicle travels out of the road in response to detecting that the target vehicle travels into a non-road area from the road area.

6. The method according to claim 1, wherein comparing the direction of travel and speed of the target vehicle with the pre-generated vehicle vector field to determine whether the target vehicle is abnormal comprises:
comparing the direction of travel of the target vehicle with a direction of the pre-generated vehicle vector field; and
determining that a trajectory of the target vehicle is abnormal in response to determining that an included angle exceeds a predetermined threshold.

7. The method according to claim 6, further comprising:
determining that a vehicle collision occurs in response to determining that a number of vehicles of which trajectories are abnormal at a given position exceeds two.

8. An electronic device comprising:
at least one processor; and
a storage device that stores instructions that, when executed by the at least one processor, causes the at least one processor to perform operations for detecting a traffic anomaly, the operations comprising:
acquiring at least two frames of consecutive traffic images;
identifying respectively a position of a target vehicle from the at least two frames of consecutive traffic images to obtain a position information set;
determining a direction of travel and speed of the target vehicle according to the position information set; and
comparing the direction of travel and speed of the target vehicle with a pre-generated vehicle vector field to determine whether the target vehicle is abnormal.

9. The electronic device according to claim 8, the operations further comprising:
acquiring a traffic video of a predetermined length of time;
creating a matrix of a size identical to a size of a screen of the traffic video, wherein each element in the matrix represents one pixel point on the screen, and an initial value of each element in the matrix is zero;
tracking and detecting a vehicle in the traffic video, and setting an element corresponding to a pixel point in a detection box of the vehicle to a non-zero value; and
determining a pixel point corresponding to a non-zero value in the matrix as a road to obtain a road area.

10. The electronic device according to claim 9, the operations further comprising:
obtaining a vehicle trajectory set according to a change of a position of the detection box of the vehicle; and
performing a cluster analysis on the vehicle trajectory set to generate a vehicle vector field.

11. The electronic device according to claim 9, wherein the operation of comparing the direction of travel and speed of the target vehicle with a pre-generated vehicle vector field to determine whether the target vehicle is abnormal comprises:
determining that the target vehicle stops abnormally in response to determining that a time during which the position of the target vehicle is in the road area and the speed is zero exceeds a predetermined duration threshold.

12. The electronic device according to claim 9, wherein the operation of comparing the direction of travel and speed of the target vehicle with a pre-generated vehicle vector field to determine whether the target vehicle is abnormal comprises:
determining that the target vehicle travels out of the road in response to detecting that the target vehicle travels into a non-road area from the road area.

13. The electronic device according to claim 8, wherein the operation of comparing the direction of travel and speed of the target vehicle with a pre-generated vehicle vector field to determine whether the target vehicle is abnormal comprises:
comparing the direction of travel of the target vehicle with a direction of the pre-generated vehicle vector field; and
determining that a trajectory of the target vehicle is abnormal in response to determining that an included angle exceeds a predetermined threshold.

14. The electronic device according to claim 13, the operations further comprising:
determining that a vehicle collision occurs, in response to determining that a number of vehicles of which trajectories are abnormal at a given position exceeds two.

15. A non-transitory computer-readable storage medium, storing computer instructions, wherein the computer instructions are executable by a computer to cause the computer to perform operations for detecting a traffic anomaly, the operations comprising:
acquiring at least two frames of consecutive traffic images;
identifying respectively a position of a target vehicle from the at least two frames of consecutive traffic images to obtain a position information set;
determining a direction of travel and speed of the target vehicle according to the position information set; and comparing the direction of travel and speed of the target vehicle with a pre-generated vehicle vector field to determine whether the target vehicle is abnormal.

16. The non-transitory computer-readable storage medium according to claim 15, the operations further comprising:
acquiring a traffic video of a predetermined length of time;
creating a matrix of a size identical to a size of a screen of the traffic video, wherein each element in the matrix represents one pixel point on the screen, and an initial value of each element in the matrix is zero;
tracking and detecting a vehicle in the traffic video, and setting an element corresponding to a pixel point in a detection box of the vehicle to a non-zero value; and
determining a pixel point corresponding to a non-zero value in the matrix as a road to obtain a road area.

17. The non-transitory computer-readable storage medium according to claim 16, the operations further comprising:
obtaining a vehicle trajectory set according to a change of a position of the detection box of the vehicle; and
performing a cluster analysis on the vehicle trajectory set to generate a vehicle vector field.

18. The non-transitory computer-readable storage medium according to claim 16, wherein the operation of comparing the direction of travel and speed of the target vehicle with a pre-generated vehicle vector field to determine whether the target vehicle is abnormal comprises:
determining that the target vehicle stops abnormally in response to determining that a time during which the position of the target vehicle is in the road area and the speed is zero exceeds a predetermined duration threshold.

19. The non-transitory computer-readable storage medium according to claim 16, wherein the operation of comparing the direction of travel and speed of the target vehicle with a pre-generated vehicle vector field to determine whether the target vehicle is abnormal comprises:
determining that the target vehicle travels out of the road in response to detecting that the target vehicle travels into a non-road area from the road area.

20. The non-transitory computer-readable storage medium according to claim 15, wherein the operation of comparing the direction of travel and speed of the target vehicle with a pre-generated vehicle vector field to determine whether the target vehicle is abnormal comprises:
comparing the direction of travel of the target vehicle with a direction of the pre-generated vehicle vector field; and
determining that a trajectory of the target vehicle is abnormal in response to determining that an included angle exceeds a predetermined threshold.
